(19) United States
(12) Patent Application Publication
(10) Pub. No.: US 2016/0146020 A1
(43) Pub. Date: May 26, 2016

(54) BRAZING METHOD FOR REINFORCING THE Z-NOTCH OF TiAl BLADES

(71) Applicant: MTU Aero Engines AG, Munich (DE)

(72) Inventors: Karl-Hermann RICHTER, Markt Indersdorf (DE); Herbert HANRIEDER, Hohenkammer (DE)

(21) Appl. No.: 14/948,526

(22) Filed: Nov. 23, 2015

(30) Foreign Application Priority Data
Nov. 26, 2014 (DE) 102014224156.1

(51) Int. Cl. F01D 5/28; C22C 19/05; C22C 19/07; B23K 1/00; B23K 35/30; B23K 11/11; B23K 11/20; B23K 11/00; F01D 5/14; B23K 35/02

(52) U.S. Cl. CPC F01D 5/282; F01D 5/147; C22C 19/058; C22C 19/07; B23K 35/0233; B23K 35/304; B23K 11/11; B23K 11/20; B23K 11/0033; B23K 1/0018; F05D 2220/321; F05D 2230/237; F05D 2240/30; F05D 2300/174; B23K 2203/26

(57) ABSTRACT

The present invention relates to a method for arranging a reinforcement (8, 9) on a TiAl component (1) of a turbomachine, the reinforcement being formed by a reinforcing molding, which is applied to the TiAl component (1) by means of brazing, a nickel-base alloy with the chemical composition 7.5% to 22.5% by weight Cr, 0.5% to 7% by weight B, remainder Ni, being used as the brazing filler metal.

### CROSS-REFERENCE TO RELATED APPLICATIONS

The present application claims priority under 35 U.S.C. §119 of German Patent Application No. 102014224156.1, filed Nov. 26, 2014, the entire disclosure of which is expressly incorporated by reference herein.

### BACKGROUND OF THE INVENTION

1. Field of the Invention

The present invention relates to a method for arranging a reinforcement on a TiAl component of a turbomachine, in particular a TiAl engine part, and to a corresponding component provided with the reinforcement, for example an engine component, in particular a rotor blade of a low-pressure turbine.

2. Discussion of Background Information

Turbine blades for low-pressure turbines of aircraft engines may comprise cover shrouds, which lie adjacently against one another. The adjacent side faces are usually of a Z-shaped form and have contact areas in which the cover shrouds butt directly against one another in order to play a part in damping vibration. These contact areas of the cover shrouds are usually provided with a reinforcement, in order to keep down the amount of mechanical abrasion.

According to the prior art, Co—Cr alloys are used for this, in particular so-called Stellites (registered trademark of the company Deloro Stellite), which are applied for example by TIG, microplasma or laser-beam welding, or by some other build-up welding method. While this kind of reinforcement is well-suited for nickel-base alloys or superalloys, it is problematic in the case of turbine blades made of titanium aluminides (TiAl alloys), since the mixing of TiAl with Stellites has the effect of producing brittle phases, which may lead to the formation of cracks.

For this reason, plasma-sprayed layers of the Co—Cr alloy T-800 (registered trademark of the company Deloro Stellite) have been used in the case of TiAl blades of low-pressure turbines. However, under some circumstances these coatings or reinforcements do not meet the requirements with respect to their adhesive properties.

Consequently, it has also been proposed for reinforcing the contact areas of cover shrouds of TiAl low-pressure turbine blades (the so-called Z-notches) to apply moldings of Stellites by brazing (see WO 2011/009430, the entire disclosure of which is incorporated by reference herein). Although it has already been possible to achieve good results with these, there is still a further need for an improvement in the bonding of the reinforcement to the TiAl component and for an optimized method for producing the reinforcement.

The invention therefore is concerned with the problem of avoiding the disadvantages of the prior art and allowing a reinforcement on a TiAl component, in particular a TiAl low-pressure turbine blade, it being intended that the coating can be easily carried out and that it should provide reliable results in terms of a reinforcement that adheres well.

### SUMMARY OF THE INVENTION

The present invention provides a method for arranging a reinforcement on a TiAl component of a turbomachine. The reinforcement is formed by a reinforcing molding, which is applied to the TiAl component by means of brazing. A nickel-base alloy which comprises, based on the total weight of the alloy, from about 7.5% to about 22.5% by weight Cr and from about 0.5% to about 7% by weight B, the remainder being Ni and unavoidable impurities, is used as the brazing filler metal.

In one aspect of the method, the brazing filler metal may be formed from a nickel-base alloy which comprises from about 10% to about 20% by weight Cr, e.g., from about 12.5% to about 17.5% by weight Cr, or about 15% by weight Cr, and from about 2% to about 5% by weight B, e.g., from about 3% to about 4% by weight B, or about 3.5% by weight B.

In another aspect of the method of the present invention, the reinforcing molding may be formed from a metallic material, for example from a Co—Cr alloy. The Co—Cr alloy may be a Co-base alloy with a Cr fraction of more than about 25% by weight, based on the total weight of the alloy. This alloy may further comprise one or more of the following (in weight percent): from about 4% to about 20% W, from about 1% to about 3% C, up to about 1.5% Si, up to about 3% Fe, up to about 3% Ni.

In yet another aspect of the method, the brazing filler metal may be attached to the reinforcing molding as a brazing foil, in particular with an overhang, e.g., by spot welding and/or resistance welding and/or adhesive bonding.

In a still further aspect, the reinforcing molding may be formed as a parallelepiped with two diagonally opposite edges, which are rounded off, so that one surface has a convex curvature with a radius of curvature, the reinforcing molding being formed in longitudinal section as a parallelogram, in which the opposite corners are rounded off, and in cross section forming a rectangle.

In another aspect of the method, the TiAl component may be provided with a pocket which is at least partially complementary to the reinforcing molding.

In another aspect, the TiAl component may be surface-treated, at least in the region of the pocket and/or the reinforcing molding, before the application of the reinforcing molding in the pocket. For example, the component may be blasted with particles, such as SiC particles.

In another aspect of the method of the present invention, the reinforcing molding may be held during the brazing by a bar, e.g., a ceramic bar or graphite bar or glass bar, and/or the brazing process may be monitored and/or controlled in an open-loop and/or closed-loop manner by means of a pyrometer and/or a thermal imaging camera.

The present invention also provides a component of a turbomachine with a reinforcement which is produced by the method of the present invention as set forth above (including the various aspects thereof).

As set forth above, according to the present invention it is proposed to form the reinforcement on a TiAl component by a reinforcing molding, which is applied to the TiAl component by means of brazing, a nickel-base alloy with the chemical composition comprising, based on the total weight of the alloy, from about 7.5% to about 22.5% by weight Cr, from about 0.5% to about 7% by weight B, and nickel and unavoidable impurities as the remainder, being used as the brazing filler metal. Such a filler metal composition has been found to be advantageous for a stable and reliable brazed connection.

In particular, the nickel-base alloy that is used as the brazing filler metal may have a chemical composition comprising from about 10% to about 20% by weight, e.g., from about 12.5% to about 17.5% by weight, or about 15% by weight Cr and also from about 2% to about 5% by weight, e.g., from about 3% to about 4% by weight, or about 3.5% by weight B, and the remainder Ni and unavoidable impurities.

The reinforcing molding may be formed from a metallic material, hard-material alloys being able to be used in particular. Co—Cr alloys, in particular Co-base alloys with a chromium fraction of more than about 25% by weight and W fractions of from about 4% to about 20% by weight may find consideration for use as the material for the reinforcement. Examples of this are in particular the Stellite alloys from the Deloro Stellite company.

The brazing filler metal may be arranged as a brazing foil, it being possible in particular for adhesive attachment of the brazing foil to the reinforcing molding to be accomplished before the attachment of the reinforcing molding to the TiAl component. The adhesive attachment of the brazing foil to the reinforcing molding may be accomplished by, for example, spot welding, resistance welding and/or adhesive bonding.

The reinforcing molding may have a particular form that allows complete and reliable brazing of the reinforcing molding to the TiAl component. In particular, the reinforcing molding may have a convexly curved surface area, it being possible for the convexly curved surface area to be inserted into a concavely curved surface area of a pocket of the TiAl component, in order to accomplish a particularly stable and reliable connection of the molding to the TiAl component by way of a brazing layer as a result of the complementary formation of the convex surface part of the reinforcing molding and the concave surface of the receiving pocket of the TiAl component.

Before the brazing or attachment of the reinforcing molding to the TiAl component, both the TiAl component in the area of the application site and the reinforcing molding may be surface-treated, to be precise in particular by blasting with particles, e.g., SiC particles, so that a cleaning and compaction of the surfaces takes place. Instead of correspondingly treating both surfaces that are to be connected, that is to say the surface of the reinforcing molding and the surface of the TiAl component, it is also possible for a surface treatment only to be performed on one of the surfaces.

To ensure a good brazed connection, the reinforcing molding may be fixed during the brazing, in particular by a bar that securely holds the reinforcing molding on the TiAl component. The bar may be a ceramic bar, a glass bar or a graphite bar, a graphite bar being advantageous in particular, since the good thermal conductivity of the graphite makes it possible to set a uniform temperature over the reinforcing molding during the brazing.

The brazing method itself may be monitored by means of a pyrometer and a thermal imaging camera, so that, with the result of the monitoring, specific open-loop and/or closed-loop control of the brazing method is possible. If inductive heating is used for the brazing, suitable open-loop and/or closed-loop temperature control can be accomplished with the aid of the monitoring results of the pyrometer and/or thermal imaging camera.

The brazing may be carried out at a brazing temperature of from about 1050° C. to about 1130° C., e.g., at about 1090° C., it being possible for the holding time at the brazing temperature to lie in the range from about 10 s to about 300 s.

A TiAl component is understood in the case of the present invention as being a component that is formed from a TiAl material, that is to say a material in which Ti and Al are contained as the main constituents of an alloy composition. It comprises in particular TiAl alloys that form intermetallic phases in the form of titanium aluminides, such as gamma-TiAl or α2Ti3Al.

### BRIEF DESCRIPTION OF THE DRAWINGS

In the purely schematic accompanying figures:

FIG. 1 shows a plan view of a cover shroud of a rotor blade of an aircraft engine,

FIG. 2 shows a perspective representation of a reinforcing molding with attached brazing foil,

FIG. 3 shows in sub-figures a) and b) a longitudinal section (a) and a plan view (b) of the reinforcing molding from FIG. 2 and

FIG. 4 shows a side view of an arrangement when brazing the reinforcing molding to the TiAl component.

### DETAILED DESCRIPTION OF EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

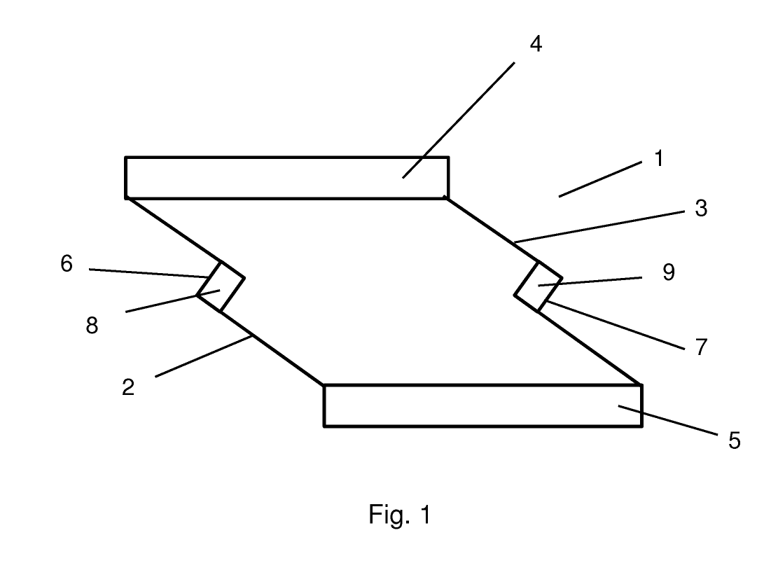

FIG. 1 shows a plan view of a cover shroud 1 of a rotor blade, as can be used for example in a low-pressure turbine of an aircraft engine. The rotor blade and the cover shroud 1 consist of a high-strength, high-temperature-resistant titanium-aluminide alloy, that is to say an alloy that is formed substantially from intermetallic phases, such as α₂-Ti₃Al or γ-TiAl, and is referred to here generally as the TiAl alloy. The cover shroud 1 has a substantially sheet-like configuration with two outer sealing lips or sealing webs 4, 5, which are spaced apart from one another and extend in the rotational direction, and two Z-shaped side faces 2 and 3, which lie against adjacent moving blades or cover shrouds. The Z-shaped side faces 2, 3 respectively have a contact area 6, 7 for mutual contact with adjacent moving blades or cover shrouds for damping vibration. To reduce the abrasion at the contact areas 6, 7, they are respectively provided with a reinforcement 8, 9.

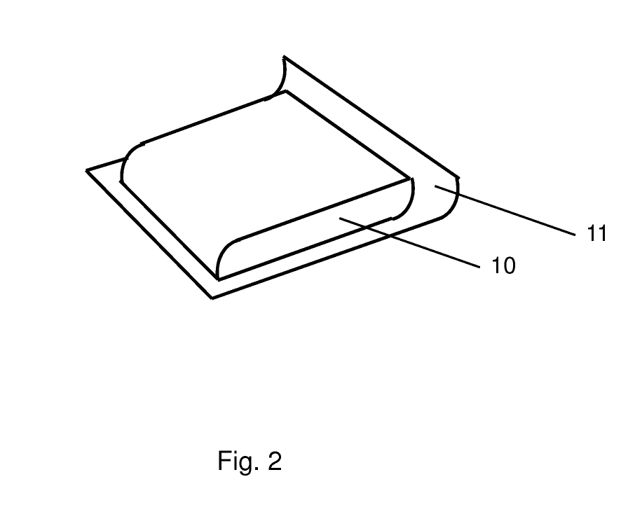

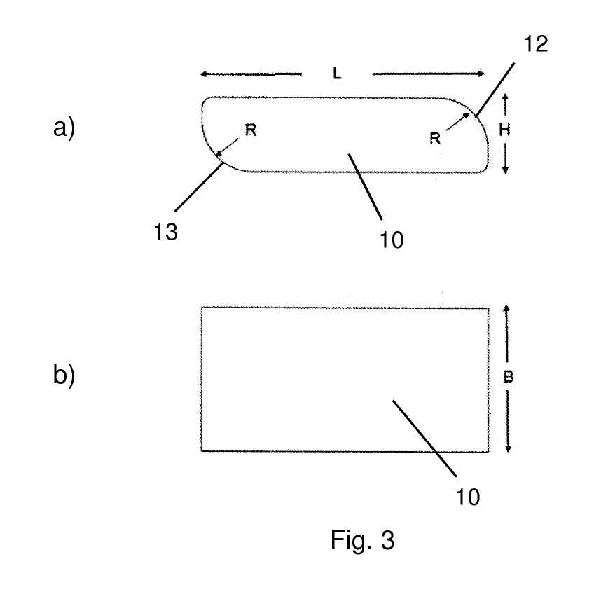

The reinforcements 8, 9 that are provided on the contact areas 6, 7 of the cover shroud 1 are formed from reinforcing moldings 10 (see FIG. 2 and FIG. 3), which are brazed on the cover shroud 1. As shown in FIG. 2, a brazing foil 11, which is attached to the reinforcing molding 10, is used for the brazing. The attachment of the brazing foil may be performed by spot welding and in particular resistance spot welding or adhesive bonding. The adhesive with which the brazing foil 11 can be attached to the reinforcing molding 10 should be chosen such that the adhesive rapidly evaporates already at a temperature below the brazing temperature in a vacuum, so that the adhesive does not have any adverse effects on the production of the brazing layer and is not incorporated in the brazing layer.

The thickness of the brazing foil 11 may be chosen in the range from about 25 μm to about 100 μm, e.g. about 50 μm.

As shown in FIG. 2, the brazing foil may be formed with an overhang with respect to the reinforcing molding 10, to be precise with an overhang of from about 0.1 mm to about 1 mm with respect to the width B of the reinforcing molding 10 (see FIG. 3b) or with an overhang of from about 0.1 mm to about 2 mm in the longitudinal direction L (see FIG. 3a). It is ensured by the overhang of the brazing foil 11 that complete wetting of the reinforcing molding 10 and the bearing surface on the cover shroud 1 takes place, so that the brazing layer can be formed over the full surface area.

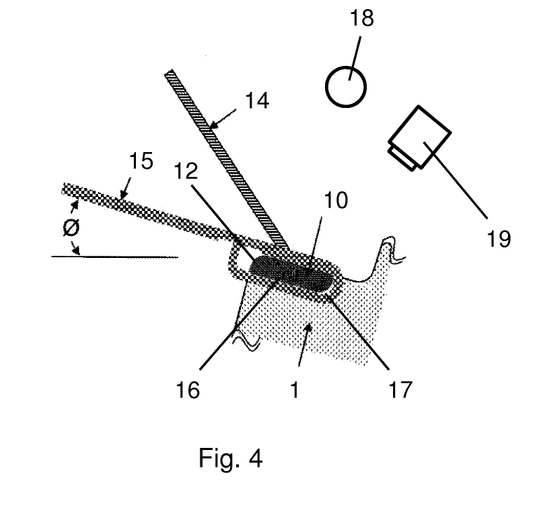

The reinforcing molding 10 has substantially the basic form of a parallelepiped, in particular a cuboid, two edges that run in the direction of the width and are arranged lying diagonally opposite being rounded off and forming convexly curved surface areas 12, 13. With such a form, the reinforcing moldings can be placed particularly well in pockets 16, which can be formed in the region of the so-called Z-notch (Z-groove), as shown in FIG. 4. The pockets 16 may have a form that is at least partially complementary to the form of the reinforcing moldings 10, in particular a concave curvature 17, which corresponds to the convex curvature 12, 13 of the reinforcing molding 10 at the rounded-off edge, so that the reinforcing molding is arranged on the cover shroud 1 over a continuous surface area.

The convex curvature 12 of the reinforcing molding 10 opposite the convex curvature that is accommodated in the concave curvature of the cover shroud 1 on the one hand allows better contact to be made with the cover shroud of the adjacent rotor blade and on the other hand allows universal use of a corresponding reinforcing molding 10 both on one side and on the other side of corresponding Z-grooves of the cover shroud 1.

As shown in FIG. 3 with sub-figures a) and b), the reinforcing moldings 10 are defined by a corresponding length L, a height H and a width B, which are adapted to the corresponding dimensions of the associated pockets 16 in the cover shroud 1 of the TiAl rotor blades.

The correspondingly formed pockets 16 of the cover shroud 1 and also the reinforcing moldings 10 may be surface-treated before the brazing, in particular before the attachment of the brazing foil 11 to the reinforcing molding 10, as shown in FIG. 2, so that there is a cleaning and preparation of the respective surface for the subsequent brazing method. A suitable surface pretreatment is, for example, that of blasting the surfaces with particles, for example SiC particles, in order to remove corresponding contamination and/or to compact the surface.

After the brazing foil 11 has been applied to the reinforcing molding 10 and the reinforcing molding 10 prepared in this way has been arranged in a pocket 16 of the cover shroud 1, the reinforcing molding 10 is fixed by means of a bar 14, so that a defined position of the reinforcing molding can be ensured during the brazing method and a connection of the reinforcing molding 10 to the cover shroud 1 over the full surface area can be ensured.

The bar 14 may consist of or comprise glass, ceramic or graphite and in particular be formed from isostatically pressed graphite. Graphite or isostatically pressed graphite (isographite) is preferred because this material has a high thermal conductivity, so that heat can be dissipated via the bar 14 during the brazing process and a uniform temperature distribution over the TiAl base material of the cover shroud 1 and the reinforcing molding 10 can consequently be achieved.

Apart from the fixing with the bar 14, reliable fixing of the reinforcing molding 10 in the pocket 16 is ensured by the TiAl component being arranged during the brazing method inclined in such a way that the reinforcing molding 10, and in particular the convex surface thereof, is pressed by the force of gravity into the pocket 16 and the concave recess 17. The angle of inclination θ may be chosen for example in the range from about 5° to about 30° with respect to the horizontal.

The brazing is performed by means of the brazing foil 11 and an inductive heating of the brazing foil 11 or the brazing filler metal, as illustrated in FIG. 4 by the coil 15. The brazing process is performed in a vacuum chamber (not shown) or under a corresponding shielding gas atmosphere. The brazing temperature is from about 1050° C. to about 1130° C., e.g., about 1090° C. The brazing time or the holding time of the brazing temperature ranges from about 10 seconds to about 300 seconds, e.g., around 30 seconds. The cooling down to a temperature in the range of from about 700° C. to about 900° C. takes place at a cooling-down rate in the range from about 5 K/min to about 100 K/min.

As represented in FIG. 4, a pyrometer 18, which uses an open-loop and/or closed-loop control device that is not represented to influence the operation of the induction coil 15 in such a way that the brazing temperature and the cooling-down rates lie in the desired ranges, is provided for monitoring the brazing temperature and the cooling-down rate. In addition, the melting of the brazing foil 11 may be monitored by a thermal imaging camera 19, in order to ensure a reliable and stable connection of the reinforcing molding 10 and the cover shroud 1 by a controlled and defined brazing process.

Thus, reworking of the cover shroud 1 with the reinforcing molding 10 is usually no longer necessary.

As is immediately evident, the method presented can be used not only for producing a reinforcement of a Z-notch on cover shrouds of TiAl moving blades, which has been described in detail above, but also for repairs to such components.

In addition, the method according to the invention may of course also be used with other components or for producing and repairing other reinforcements and/or on other components.

Although the present invention has been described in detail on the basis of the exemplary embodiments, it is self-evident to a person skilled in the art that the invention is not restricted to these exemplary embodiments, but rather that modifications are possible in such a way that individual features may be omitted or other combinations of features presented may be implemented without departing from the scope of protection of the accompanying claims. The present invention comprises in particular all combinations of all of the individual features presented.

### LIST OF REFERENCE NUMERALS

1 Cover shroud
2, 3 Side faces
4, 5 Sealing lips
6, 7 Contact areas
8, 9 Reinforcement
10 Reinforcing molding
11 Brazing foil
12, 13 Convex surfaces
14 Bar
15 Induction area
16 Pocket
17 Concave surface area
18 Pyrometer
19 Thermal imaging camera

What is claimed is:

1. A method for arranging a reinforcement on a TiAl component of a turbomachine, wherein the method comprises applying to the TiAl component a reinforcement in the form of reinforcing molding by brazing, using as brazing filler metal a nickel-base alloy which comprises, based on a total weight of the alloy, from 7.5% to 22.5% by weight Cr and from 0.5% to 7% by weight B, remainder Ni and unavoidable impurities.

2. The method of claim 1, wherein the nickel-base alloy comprises from 10% to 20% by weight Cr and from 2% to 5% by weight B.

3. The method of claim 2, wherein the nickel-base alloy comprises from 12.5% to 17.5% by weight Cr.

4. The method of claim 2, wherein the nickel-base alloy comprises from 3% to 4% by weight B.

5. The method of claim 3, wherein the nickel-base alloy comprises from 3% to 4% by weight B.

6. The method of claim 4, wherein the nickel-base alloy comprises about 3.5% by weight B.

7. The method of claim 3, wherein the nickel-base alloy comprises about 15% by weight Cr.

8. The method of claim 1, wherein the reinforcing molding is formed from a metallic material.

9. The method of claim 8, wherein the reinforcing molding is formed from a Co base alloy.

10. The method of claim 9, wherein the Co-base alloy is a Co—Cr alloy which comprises more than 25% by weight Cr, based on a total weight of the alloy.

11. The method of claim 10, wherein the Co-base alloy comprises, based on a total weight of the alloy, one or more of from 4% to 20% by weight W, 1% to 3% by weight C, 0% to 1.5% by weight Si, 0% to 3% by weight Fe, 0% to 3% by weight Ni.

12. The method of claim 1, wherein the brazing filler metal is attached to the reinforcing molding as a brazing foil.

13. The method of claim 12, the brazing foil is attached to the reinforcing molding by spot welding and/or resistance welding and/or adhesive bonding.

14. The method of claim 1, wherein the reinforcing molding is formed as a parallelepiped with two diagonally opposite edges, which are rounded off, so that one surface has a convex curvature with a radius of curvature, the reinforcing molding being formed in longitudinal section as a parallelogram, in which opposite corners are rounded off, and in cross section forming a rectangle.

15. The method of claim 1, wherein the TiAl component is provided with a pocket which is at least partially complementary to the reinforcing molding.

16. The method of claim 15, wherein the TiAl component is surface-treated, at least in a region of the pocket and/or the reinforcing molding, before application of the reinforcing molding in the pocket.

17. The method of claim 16, wherein the TiAl component is surface-treated by blasting it with particles.

18. The method of claim 1, wherein the reinforcing molding is held during brazing by a bar.

19. The method of claim 1, wherein the brazing process is monitored and/or controlled in an open-loop and/or closed-loop manner by a pyrometer and/or a thermal imaging camera.

20. A component of a turbomachine with a reinforcement, wherein the reinforcement is produced by the method of claim 1.
